(19) United States
(12) Patent Application Publication
(10) Pub. No.: US 2025/0296839 A1
(43) Pub. Date: Sep. 25, 2025

(54) GENERATION OF OXYGEN FROM ACTIVATED ALUMINUM AND INORGANIC ACIDS

(71) Applicant: Massachusetts Institute of Technology, Cambridge, MA (US)

(72) Inventors: Jude Kelley, Bolton, MA (US); Eric Morgan, Harvard, MA (US)

(73) Assignee: Massachusetts Institute of Technology, Cambridge, MA (US)

(21) Appl. No.: 19/033,841

(22) Filed: Jan. 22, 2025

Related U.S. Application Data
(60) Provisional application No. 63/568,962, filed on Mar. 22, 2024.

(51) Int. Cl. C01B 13/02; C01B 21/02; C01B 21/36; C01F 7/66

(52) U.S. Cl. CPC C01B 13/0203; C01B 21/02; C01B 21/36; C01F 7/66; C01P 2006/80

(57) ABSTRACT

Oxygen generators and methods related to the generation of oxygen using activated aluminum alloys and inorganic acids such as nitric acid are generally described. In some embodiments, aluminum nitrate is thermally decomposed to produce oxygen and nitrogen dioxide. The nitrogen dioxide may also optionally be used to produce oxygen gas. In some embodiments, a reaction between nitric acid and an activated aluminum alloy may be used to produce the aluminum nitrate. In other embodiments, a reaction between nitric acid and aluminum hydroxide may be used to produce the aluminum nitrate.

### RELATED APPLICATIONS

This application claims priority under 35 U.S.C. § 119(e) to U.S. Provisional Patent Application No. 63/568,962, filed Mar. 22, 2024, which is incorporated herein by reference in its entirety for all purposes.

### GOVERNMENT SPONSORSHIP

This invention was made with government support under FA8702-15-D-0001 awarded by the U.S. Air Force. The government has certain rights in the invention.

### TECHNICAL FIELD

The production of oxygen gas using activated aluminum alloys and inorganic acids, such as nitric acid, is generally described.

### BACKGROUND

Oxygen production presents certain challenges for applications such as energy, aerospace, and transportation among others. For example, oxygen is typically shipped in the form of a compressed gas cylinder or specialized cryogenic liquid tanker. This type of handling and storage associated with oxygen oftentimes increases costs, process inefficiencies, and adds additional constraints to the use and transport of oxygen for various applications.

### SUMMARY

The subject matter of the present disclosure involves, in some cases, interrelated products, alternative solutions to a particular problem, and/or a plurality of different uses of one or more systems and/or articles.

In one set of embodiments, a method for producing oxygen gas is included. In certain embodiments, the method comprises producing aluminum nitrate using an activated aluminum alloy and nitric acid. In some embodiments, the method comprises heating the aluminum nitrate to produce the oxygen gas.

In another set of embodiments, an oxygen generator is described. According to some embodiments, one or more chambers are included. In some embodiments, the oxygen generator comprises an activated aluminum alloy source configured to provide activated aluminum alloy to at least one of the one or more chambers. According to certain embodiments, the oxygen generator comprises a nitric acid source configured to provide nitric acid to at least one of the one or more chambers to produce aluminum nitrate using the activated aluminum alloy and the nitric acid. In certain embodiments, the oxygen generator comprises a heater configured to heat the aluminum nitrate to a temperature greater than a decomposition temperature of the aluminum nitrate to produce oxygen gas.

Other advantages and novel features of the present disclosure will become apparent from the following detailed description of various non-limiting embodiments of the disclosure when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present disclosure will be described by way of example with reference to the accompanying figures, which are schematic and are not intended to be drawn to scale unless otherwise indicated. In the figures, each identical or nearly identical component illustrated is typically represented by a single numeral. For purposes of clarity, not every component is labeled in every figure, nor is every component of each embodiment of the disclosure shown where illustration is not necessary to allow those of ordinary skill in the art to understand the disclosure. In the figures:

FIG. 1 schematically shows an oxygen generator and associated reaction sequence in which one or more chambers are used to produce oxygen gas using an activated aluminum alloy and an inorganic acid, according to some embodiments;

FIG. 2 shows a schematic diagram of a method of producing oxygen gas using an activated aluminum alloy and an inorganic acid, according to some embodiments;

FIG. 3 schematically shows an oxygen generator and associated reaction sequence in which one or more chambers are used to produce oxygen gas using an activated aluminum alloy and an inorganic acid, according to some embodiments;

FIG. 4 shows a schematic diagram of a method of producing oxygen gas using an activated aluminum alloy and an inorganic acid, including forming an aluminum hydroxide precursor, according to some embodiments; and

FIG. 5 is a graph of a thermogravimetric analysis of aluminum nitrate, according to some embodiments.

### DETAILED DESCRIPTION

Oxygen, such as compressed oxygen gas or liquified oxygen, is useful in many applications, including healthcare, transportation, and manufacturing. Additionally, underwater vehicles, space stations, high-altitude vehicles (e.g., high-altitude balloons), space propulsion, and/or other applications may operate in environments where oxygen may not be easily available in a desired concentration, pressure, or other desired operating parameter. Therefore, it may be necessary to either store and/or generate oxygen for the desired usage. However, typical oxygen generation and/or storage system are bulky, heavy, and/or energy intensive. Thus, existing techniques for generating oxygen may not be feasible for use in many applications. For example, a technique known as cryogenic distillation can harvest oxygen from air, however, it generally requires sophisticated equipment such as cryogenic tanks which be energetically demanding and expensive. Furthermore, cryogenic distillation may be limited to having oxygen-rich air, which may not be present in certain situations or settings.

In view of the above, the Inventors have recognized that oxygen can be generated via processes and reactions involving activated aluminum alloys and an inorganic acid such as nitric acid to form aluminum nitrate. The aluminum nitrate may then be heated to a temperature greater than a thermal decomposition temperature of the aluminum nitrate to produce oxygen (e.g., oxygen gas). The aluminum nitrate may be produced in several ways. For example, in some embodiments, it has been recognized that a reaction involving an activated aluminum alloy and water may be used to produce aluminum hydroxide which may then be reacted with the inorganic acid (e.g., nitric acid) to produce the aluminum nitrate. In other embodiments, the activated aluminum alloy may be reacted directly with the inorganic acid (e.g., nitric acid) to produce the aluminum nitrate. As elaborated on further below, in some embodiments, the noted reactions may also produce nitrogen dioxide, which can be further converted to oxygen gas.

Certain embodiments described herein may include one or more chambers, as well as additional components. The one or more chambers may include any number of different chambers including but not limited to one or more of any of the following: a reaction chamber, a separation chamber, a decomposition chamber, a storage chamber, and/or other appropriate chambers. In some embodiments, at least one chamber of the one or more chambers may be a reaction chamber configured to react any appropriate combination of activated aluminum alloys, aluminum hydroxide, water, and/or nitric acid. As elaborated on further below, depending on the embodiment, either sequential reaction chambers may be used, or a single reaction chamber may be used as the disclosure is not limited in this fashion. Additionally, in some instances, the one or more reaction chambers of an oxygen generator may have one or more feeders coupled thereto that are configured to feed one or more of the reactants to the reaction chamber. The reactants (e.g., nitric acid, water, and/or activated aluminum alloy) being fed to the one or more chambers (e.g., first reaction chamber, second reaction chamber) may undergo a reaction (e.g., a reaction between an activated aluminum alloy and nitric acid, a reaction between an activated aluminum alloy and water, a reaction between aluminum hydroxide and nitric acid, etc.). One or more heaters may be configured to heat any one of the chambers to either facilitate reaction of one or more reactants therein and/or to thermally decompose one or more products (e.g., thermal decomposition of aluminum nitrate) such that certain products (e.g., oxygen gas, nitrogen dioxide) may be produced.

As elaborated on further below, a reaction chamber (e.g., first reaction chamber) may be in fluid communication or otherwise connected with another of the one or more chambers (e.g., a second reaction chamber, a separation chamber, a decomposition chamber, a storage container, and/or other appropriate chamber), such that components (e.g., reactants, products) can be transported between such chambers and additional reactions or processes may occur, as further explained later herein. The components (e.g., reactants, products) may be transported non-continuously (i.e., in a batch) or continuously between some of the one or more chambers. For example, a first reaction chamber may have products generated in a first batch, where such products may be moved to a second reaction chamber such that a second batch of products can be generated in the first reaction chamber. Alternatively, in certain embodiments, the components may be transported continuously between the one or more chambers, such that the system may be operated continuously.

Depending on the products produced in a particular chamber and/or the processes to be performed, any appropriate method for transporting the products produced in one chamber to another chamber may be used. For example, fluid connections using gravity, pumps, or other appropriate methods for transporting a gas, liquid, and/or slurry between two chambers and/or other components may be used. This may include the use of tubes, hoses, pipes, pumps, pressure based flow arrangements, combinations of the forgoing, or other appropriate constructions. Alternatively or additionally, solid materials may be transported between two chambers and/or components using for example, conveyors, gravity fed hoppers, screw feeders, and/or other appropriate systems capable of transporting solid materials between desired processes. Alternatively, single batch processing in a single chamber and/or manual transport of products from one chamber to another may also be used as the disclosure is not so limited.

According to some embodiments, any of the one or more chambers may be fluidly isolated from the other chambers in an oxygen generator. For example, a separation chamber may be fluidly isolated from a decomposition chamber, such that any processes within the separation chamber may not perturb any processes within the decomposition chamber. In another example, a separation chamber may be isolated from a reaction chamber (e.g., second reaction chamber) such that components within the reaction chamber (e.g., reaction products, reaction byproducts, solvents) are not transferred to the separation chamber. Without wishing to be bound by theory, it may be advantageous to isolate any of the one or more chambers to drive a reaction (e.g., a reaction between nitric acid and activated aluminum alloys) to completion. Having isolated chambers may also be beneficial for having components transported in batches between certain chambers. Components, such as reagents and/or products, within an isolated chamber may be ejected, evaporated/sublimed, or otherwise removed from the chamber, through a valve, gate, faucet, stopcock, cock, or the like, that is configured to be moved from a closed configuration in which the chamber is isolated to an open configuration to permit the transport of components (e.g., products) out of the chamber. However, in certain embodiments, the one or more chambers may not be configured to be isolated which may be beneficial for transporting components continuously between chambers.

As noted above, one or more suitable feeders may be configured to feed certain reactants to the one or more chambers. In one aspect, a nitric acid feeder may be configured to feed nitric acid to at least one of the one or more chambers (e.g., a first reaction chamber, second reaction chamber). In another aspect, an activated aluminum alloy feeder may be configured to feed activated aluminum alloy to at least one of the one or more chambers (e.g., a first reaction chamber). In yet another aspect, a water feeder may be configured to feed water to at least one of the one or more chambers (e.g., a first reaction chamber). Other feeders configured to feed reactants or other components (e.g., inert species) that may promote desirable reactions and/or processes within the one or more chambers may also be included. Appropriate types of feeders may be used to transport a liquid or solid depending on the reactant to be transported including, but not limited to, pumps, screw feeders, conveyors, gravity fed hoppers, pressurized liquid sources, combinations of the forgoing and/or any other appropriate system capable of transporting a desired material from a material source (e.g., tank, container, or other reservoir) to a desired reaction chamber or other location.

In the above and other embodiment disclosed herein, any appropriate type of heater may be used to heat a chamber or other portion of an oxygen generator. For example, in some cases, a heater may be useful for a variety of purposes including, but not limited to, drive a reaction (i.e., initiate or accelerate a chemical reaction), evaporate a solvent, dry a product, etc. For example, a heater may be configured to heat a decomposition chamber to or above a thermal decomposition temperature of one or more materials container therein such that one or more reactions (e.g., nitrogen dioxide decomposition) may occur. As another example, a heater may be configured to heat a reaction chamber (e.g., a second reaction chamber). Appropriate heaters may include but not limited to heat exchangers configured to transfer heat between separate chambers, heat exchangers configured to transfer heat between a thermal reservoir and one or more chambers, resistive heaters, ceramic heaters, circulation heaters, metal block heaters, thermal boilers, gas-based heaters, combinations of the forgoing, and/or other appropriate heaters. In one set of embodiments, a heater may be powered by the combustion of a reaction byproduct (e.g., hydrogen gas) as detailed further below.

Depending on the embodiment, the activated aluminum alloy may comprise any appropriate shape and/or form. For example, the material may comprise pellets, balls, powders, particles, chunks of material, and/or slurries. The activated aluminum alloy may be regularly shaped, such as spherical, or may be irregularly shaped chunks. The size of the activated aluminum alloy may be uniform or varied. Alternatively, the activated aluminum alloy particles may be provided in a more continuous form, such as a powder with any appropriate size distribution for a desired application. Depending on the embodiment, the size distribution may be substantially uniform, such that the size of particles within the powder are substantially homogeneous.

In some embodiments, the activated aluminum alloy may have an average maximum transverse dimension that is greater than or equal to 100 μm, greater than or equal to 250 μm, greater than or equal to 500 μm, greater than or equal to 1 mm, greater than or equal to 5 mm, greater than or equal to 1 cm, or greater than or equal to 5 cm. The average maximum transverse dimension may be less than or equal to 10 cm, less than or equal to 8 cm, less than or equal to 5 cm, less than or equal to 2 cm, less than or equal to 1 cm, less than or equal to 5 mm, less than or equal to 1 mm, less than or equal to 500 μm, or less than or equal to 250 μm. Combinations of the above ranges are possible (e.g., greater than or equal to 10 cm and less than or equal to 100 μm. Controlling the average size of the activated aluminum alloy may be advantageous to dispense the material into a reaction chamber at a desired rate. Additionally, or alternatively, controlling the size of the activated aluminum alloy may be advantageous to minimize clogging and/or jamming while dispensing the material into the reaction chamber.

The activated aluminum alloys, in some embodiments, comprise an activating composition that may be permeated into the grain boundaries and/or subgrain boundaries of the reactant (e.g. aluminum) to facilitate its reaction with water. In some instances, the activating composition may be a eutectic, or close to eutectic composition, including for example a eutectic composition of gallium, indium, bismuth and/or tin. Thus, an aluminum alloy may include aluminum as well as one or more selected from gallium, indium, bismuth and/or tin. In one such embodiment, the activating composition may comprise gallium and indium. In other embodiments, the activating composition may comprise bismuth and tin. In one set of embodiments, the portion of the activating composition may have a composition of gallium that is greater than or equal to 70% by weight, greater than or equal to 75% by weight, or greater than or equal to 80% by weight. In another embodiments, the portion of the activating composition may have a composition of gallium that is less than or equal to 80% by weight, less than or equal to 75% by weight, or less than or equal to 70% by weight. Combinations of the recited ranges for gallium are possible (greater than or equal to 70% by weight and less than or equal to 80% by weight). In yet another set of embodiments, the portion of the activating composition may have a composition of indium that is greater than or equal to 20% by weight, greater than or equal to 25% by weight, or greater than or equal to 30% by weight. In some embodiments, the portion of the activating composition may have a composition of indium that is less than or equal to 30% by weight, less than or equal to 25% by weight, or less than or equal to 20% by weight. Combinations of the recited ranges for indium are possible (greater than or equal to 20% by weight and less than or equal to 30% by weight). Without wishing to be bound by theory, gallium and/or indium may permeate through one or more grain boundaries and/or subgrain boundaries of an alloy (e.g., aluminum alloy).

In certain embodiments, the activating composition may be incorporated into a metal alloy. A metal alloy may comprise any activating composition in any of a variety of suitable amounts. In some embodiments, for example, a weight concentration (w/w) of the metal alloy is greater than or equal to 0.1%, greater than or equal to 1%, greater than or equal to 5%, greater than or equal to 15%, greater than or equal to 30%, or greater than or equal to 45% of the activating composition, based on the total weight of the metal alloy with the balance of the alloy being aluminum. In certain embodiments, a weight concentration (w/w) of the metal alloy is less than or equal to 50%, less than or equal to 40%, less than or equal to 30%, less than or equal to 20%, less than or equal to 10%, less than or equal to 5%, or less than or equal to 1% of the activating composition, based on the total weight of the metal alloy with the balance of the alloy being aluminum. Combinations of the above recited ranges are also possible (e.g., a weight concentration (w/w) of the metal alloy is greater than or equal to 0.1% and less than or equal to 50% of the activating composition based on the total weight of the metal alloy). In some embodiments, the activating composition is incorporated into an aluminum alloy.

In some embodiments, an activated aluminum alloy may be present in a slurry. The activated aluminum alloy within a slurry may be suspended in any appropriate carrier fluid. This carrier fluid may be a shear thinning fluid, though the disclosure is not limited to only using shear thinning fluids. As used herein, the phrase “shear thinning fluid” is given its ordinary meaning in the art and generally refers to a fluid whose viscosity decreases under shear strain. Any of a variety of suitable shear thinning fluids may be utilized. In some embodiments, for example, the carrier fluid may comprise oil, such as mineral oil, canola oil, and/or olive oil. In certain embodiments, the carrier fluid may comprise a grease, alcohol, or other appropriate material capable of suspending the water-reactive particles in the carrier fluid. In certain embodiments, the carrier fluid comprises fumed silica thickening agents, or other appropriate thickening agents.

Much of the present disclosure is related to systems and method for generating oxygen, which may have several advantages. In certain situations, it may be easier to obtain, transport, and/or store solid and liquid reagents (e.g., activated aluminum alloys, water, and/or nitric acid) as compared to obtaining compressed and/or liquified oxygen for a particular use. Therefore, the disclosed oxygen generators and methods may offer economic, logistic, and other commercial benefits. For example, nitric acid, water, and/or activated aluminum alloys may be more easily obtained from local sources and/or alternatively shipped and stored for use in barrels, tankers, and other appropriate containers without the need for high pressure and/or cryogenic storage systems. These materials may then be used to generate oxygen gas at a desired location where it may be stored for future use in cylinders or other appropriate pressurized containers for future use. Alternatively, the generated oxygen may be generated on demand and directly used for a desired application. Appropriate applications may include but are not limited to, medical oxygen generation, oxygen generation in low oxygen environments (underwater, high altitude, space, etc.), combustion systems, fuel cells, and/or any other desired application where the generation of oxygen may be desired.

Turning now to the figures, specific non-limiting embodiments are described in more detail. It should be understood that various features of the separately described embodiments may be used together as the current disclosure is not limited to the specific embodiments depicted in the figures and described below. It should be understood that the following figures are not drawn to scale, unless otherwise specified.

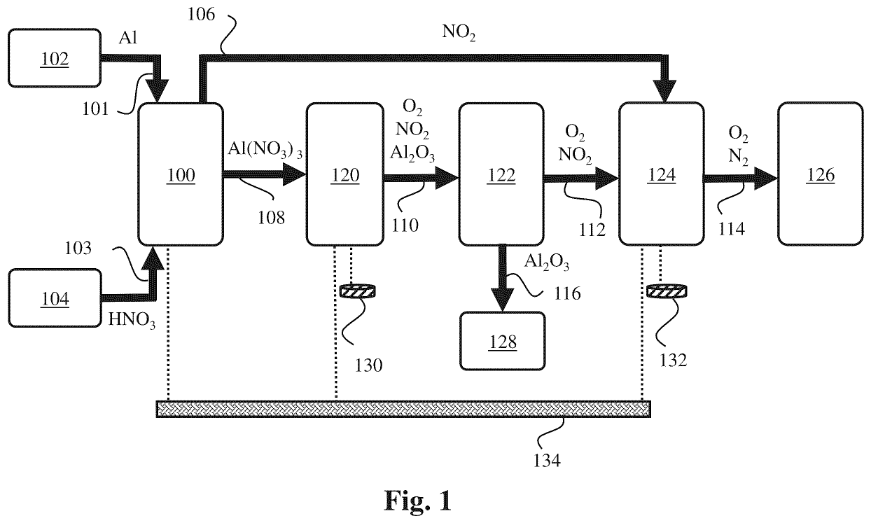

FIG. 1 schematically shows one embodiment of an oxygen generator for generating oxygen using an activated aluminum alloy and nitric acid using a reaction pathway detailed further below. In the depicted embodiment, activated aluminum alloy source 102 may be configured to feed an activated aluminum alloy via flow path 101 to first reaction chamber 100 and nitric acid source 104 may be configured to feed nitric acid via flow path 103 to first reaction chamber 100. For example, one or more material feeders may be used to transport the desired material into the first reaction chamber 100. The first reaction chamber 100 may be any appropriate reaction chamber including an interior volume and appropriate construction capable of containing the reaction between activated aluminum and nitric acid. In some embodiments, the first reaction chamber 100 may be sealed relative to the surrounding exterior environment such that any gas generated therein may be isolated from the exterior environment. First reaction chamber 100 may include an appropriate outlet that is in fluid communication with a decomposition chamber 124 via flow path 106 to transfer nitrogen dioxide gas from the first reaction chamber to the decomposition chamber. First reaction chamber 100 may also include a second outlet that is in communication with second reaction chamber 120 such that the aluminum nitrate may be transferred from the first reaction chamber 100 to the second reaction chamber 120 via flow path 108. Second reaction chamber 120 may be configured to transfer oxygen, nitrogen dioxide and/or alumina to separation chamber 122 via flow path 110 that couples the second reaction chamber 120 and the separation chamber via one or more outlets from the second reaction chamber. Separation chamber 122 may be configured to transfer alumina to first storage chamber 128 via flow path 116 that couples the separation chamber 122 and the first storage chamber 128. Separation chamber 122 may be configured to transfer oxygen and/or nitrogen dioxide to decomposition chamber 124 via flow path 112 that couples the separation chamber 122 and the decomposition chamber 124. Decomposition chamber 124 may be configured to transfer oxygen and/or nitrogen to second storage chamber 126 via flow path 114 that couples the decomposition chamber 124 and the second storage chamber 126. Alternatively, the second storage chamber 126 may be replaced by any desired device that may use the generated oxygen.

As noted previously, in some embodiments, it may be desirable to provide heat energy to one or more portions of the disclosed oxygen generator including, for example, the second reaction chamber 120 and/or the decomposition chamber 124. Thus, the generator may include a first heater 130 that is configured to heat the second reaction chamber to a desired temperature including, for example, a temperature that is greater than or equal to a thermal decomposition temperature of aluminum nitrate as elaborated on further below. Correspondingly, a second heater 132 may be configured to heat the decomposition chamber 124 to a temperature sufficient to decompose nitrogen dioxide to oxygen and nitrogen within the decomposition chamber as elaborated on further below. Given the exothermic nature of the reaction between the activated aluminum alloy and the nitric acid, in some embodiments, it may be desirable to transfer the reaction heat in the first reaction chamber 100 to one or more of the other chambers of the oxygen generator to improve an efficiency of the oxygen generator. In one such embodiment, one or more heat exchangers 134 may be configured to transfer heat from the first reaction chamber 100 to the second reaction chamber 120, the decomposition chamber 124, and/or any other appropriate chamber or process of the oxygen generator.

In the above embodiment, and other embodiments including the transfer of materials between two sequential chambers of an oxygen generator, the oxygen generator may include any appropriate type of construction capable of transfer the resulting materials to the next downstream component. For example, pumps, gravity-based flow arrangements, pressurized flow of a material along a flow path, and/or any other appropriate arrangement may be used to transfer gases, liquids, and/or slurries between the outlet and inlet ports of sequentially arranged chambers of an oxygen generator. Correspondingly, any appropriate type of feeder capable of transporting a solid material between sequentially located chambers may be used with any of the embodiments disclosed herein.

The above described oxygen generator may be used to perform a reaction between nitric acid and an activated aluminum alloy to generate oxygen. An example of one exemplary reaction pathway is shown below:

Al(s,activated)+6HNO₃(aq)→Al(NO₃)₃(aq)+3H₂O(l)+3NO₂(g) (1)

According to certain embodiments, an activated aluminum alloy (e.g., solid activated aluminum alloy) may react with nitric acid to form aluminum nitrate, water, and nitrogen dioxide. Referring back to FIG. 1, Reaction (1) may occur within first reaction chamber 100. The first reaction chamber 100 may have activated aluminum alloy and nitric acid feed into the first reaction chamber 100 from the activated aluminum alloy source 102 and nitric acid source 104. The activated aluminum alloy and nitric acid may then react via Reaction (1). First reaction chamber 100 may produce nitrogen dioxide (shown as a product of Reaction (1)), which may be removed or transported out of first reaction chamber 100 through flow path 106 and into the decomposition chamber 124. Additionally, in certain cases, first reaction chamber 100 may be configured to transfer at least some of the products of Reaction (1), such as the aluminum nitrate via flow path 108 to second reaction chamber 120. As noted above, Reaction (1) may be an exothermic reaction that produces heat. Thus, the heat produced from Reaction (1) may be captured by heat exchanger 140 such that at least some of the heat is transferred to other chambers and/or processes within the oxygen generator including the second reaction chamber 120.

In embodiments involving a reaction between nitric acid and activated aluminum alloys, the first reaction chamber 100 may be maintained at a desired temperature to facilitate the reaction between nitric acid and the activated aluminum alloy. As described herein, the reaction between nitric acid and activated aluminum alloys may be an exothermic reaction. In embodiments involving a reaction chamber undergoing a reaction between nitric acid and activated aluminum alloys, the temperature of the reaction chamber may be maintained below a desired temperature to facilitate the reaction and/or to avoid damage to the oxygen generator. For example, a temperature of the first reaction chamber 100 may be maintained below a boiling temperature of the nitric acid using the illustrated heat exchanger 134 or other appropriate heat exchanger configured to remove heat from the first reaction chamber 100. In some such embodiments, the temperature is greater than or equal to 50° C., greater than or equal to 60° C., greater than or equal to 70° C., greater than or equal to 80° C., greater than or equal to 90° C., or other appropriate temperature. In embodiments involving a reaction chamber undergoing a reaction between nitric acid and activated aluminum alloys, the temperature of the reaction chamber may be less than or equal to 99° C., less than or equal to 90° C., less than or equal to 80° C., less than or equal to 70° C., less than or equal to 60° C., or less than or equal to 50° C. Combinations of the above-recited ranges are possible (e.g., greater than or equal to 50° C. and less than or equal to 99° C.).

According to some embodiments, the concentration ratio of nitric acid to activated aluminum alloy may have a suitable range. For example, a suitable concentration ratio (e.g., molar concentration ratio) of nitric acid to activated aluminum alloy may promote a reaction between the nitric acid and activated aluminum alloy. In some embodiments, the concentration ratio of nitric acid to activated aluminum is greater than or equal to 30:1, greater than or equal to 24:1, greater than or equal to 18:1, greater than or equal to 12:1, greater than or equal to 6:1, greater than or equal to 5:1, greater than or equal to 4:1, greater than or equal to 3:1, greater than or equal to 2:1, or greater than or equal to 1:1. In some embodiments, the concentration ratio of nitric acid to activated aluminum is less than or equal to 1:1, less than or equal to 2:1, less than or equal to 3:1, less than or equal to 4:1, less than or equal to 5:1, less than or equal to 6:1, less than or equal to 12:1, less than or equal to 18:1, less than or equal to 24:1, or less than or equal to 30:1. Combinations of the above-recited ranges are possible (e.g., greater than or equal to 1:1 and less than or equal to 30:1). The concentration ratio of nitric acid to activated aluminum alloys may be the concentration ratio prior to reacting. Without wishing to be bound by theory, it may be desirable to have a stoichiometric excess of nitric acid with regards to activated aluminum alloys.

The nitric acid may have any suitable concentration. The concentration of nitric acid may be the initial concentration prior to reacting nitric acid and/or prior to being transferred from a nitric acid source to a reaction chamber. In some embodiments, the concentration (v/v) of nitric acid is greater than or equal to 65%, greater than or equal to 60%, greater than or equal to 55%, greater than or equal to 50%, greater than or equal to 45%, greater than or equal to 40%, greater than or equal to 35%, greater than or equal to 30%, greater than or equal to 25%, or greater than or equal to 20%, or greater than or equal to 15%. In some embodiments, the concentration (v/v) of nitric acid is less than or equal to 20%, less than or equal to 25%, less than or equal to 30%, less than or equal to 35%, less than or equal to 40%, less than or equal to 45%, less than or equal to 50%, less than or equal to 55%, less than or equal to 60%, less than or equal to 65%, or less than or equal to 70%. Combinations of the above ranges are contemplated including, for example, a concentration that is between or equal to 15% and 70% (v/v).

As seen in FIG. 1, second reaction chamber 120 may be configured to receive the aluminum nitrate (e.g., aqueous aluminum nitrate, solid aluminum nitrate) from first reaction chamber 100. Second reaction chamber 120 may be configured to undergo the following thermal decomposition reaction of aluminum nitrate:

2Al(NO₃)₃(s)+Δq→Al₂O₃(s)+1.5O₂(g)+6NO₂(g) (2)

As shown in reaction (2), the aluminum nitrate may be heated to a temperature equal to or greater than a thermal decomposition temperature of the aluminum to produce alumina, oxygen, and nitrogen dioxide may be formed from the aluminum nitrate. The alumina, oxygen, and nitrogen dioxide may be transported via flow path 110 to separation chamber 122. In some embodiments, the second reaction chamber 120 may be configured to be heated using heat transferred from the first reaction chamber 100 via heat exchanger 134. Alternatively or additionally, the heater 130 can be used to heat second reaction chamber 120. In either case, the heat exchanger 134 and/or the heater 130 may be configured to heat the second reaction chamber 120 to the desired temperature to perform the endothermic Reaction (2).

Aluminum nitrate may decompose to oxygen, nitrogen dioxide, and alumina within a suitable temperature range. In some embodiments, the decomposition temperature of aluminum nitrate is greater than or equal to 100° C., greater than or equal to 125° C., greater than or equal to 150° C., greater than or equal to 175° C. greater than or equal to 200° C., greater than or equal to 225° C., greater than or equal to 250° C., greater than or equal to 275° C., or greater than or equal to 300° C. In some embodiments, the decomposition temperature of aluminum nitrate is less than or equal 300° C., less than or equal 275° C. less than or equal 250° C. less than or equal 225° C., less than or equal 200° C., less than or equal 175° C., less than or equal 150° C., less than or equal 125° C., less than or equal 100° C. Combinations of the above-mentioned ranges for the thermal decomposition of aluminum nitrate are possible (e.g., greater than or equal to 100° C. and less than or equal to 300° C.). In an exemplary embodiment, the decomposition of aluminum nitrate with any of the methods and systems disclosed herein may be performed at a temperature that is greater than or equal to 150° C. and less than or equal to 200° C.

As also seen in FIG. 1, separation chamber 122 may be configured to separate alumina from other species (e.g., separate alumina from oxygen and nitrogen dioxide). For example, the separation chamber may be configured to separate solid and/or liquids from gases present within the separation chamber 122. For example, membranes, gravity separation traps, and/or any other appropriate constructions may be used to separate the liquid and/or solids from gas. For example, the solid alumina may flow out of a lower waste outlet (relative to a direction gravity during operation) such that the alumina, liquids, and/or other waste materials may be transferred to first storage chamber 128 via flow path 116. The alumina and/or other materials output into the first storage chamber 128 may be subsequently used, disposed, or otherwise removed from the oxygen generator. In certain embodiments, a solid is filtered (e.g., with a mechanical filter, chemical filter, sand filter) from a liquid such that any solids (e.g., alumina) suspended in the liquid are not removed from the separation chamber. Separation chamber 122 may also be configured to transfer oxygen and nitrogen dioxide to decomposition chamber 124 via flow path 112. For example, a gas outlet located vertically above the outlet associated with the flow path 116 to the first storage chamber 128 relative to a direction of gravity during operation may be fluidly coupled to the flow path 112 to facilitate gas flow out of the separation chamber 122. In certain embodiments, water may be removed through transfer to first storage chamber 128. Alternatively, after transferring nitrogen dioxide and oxygen gas to another chamber (e.g., decomposition chamber 124), water may be removed from separation chamber 122 by evaporating the water.

To help increase an amount of oxygen generated with the disclosed reaction pathway, in some embodiments, it may be desirable to decompose the generated nitrogen dioxide to form nitrogen and oxygen gas. FIG. 1 shows decomposition chamber 124 which may be configured to receive nitrogen dioxide via flow path 106 from the first reaction chamber 100 and at least some nitrogen dioxide via flow path 112 from the separation chamber 122. The following reaction may occur within decomposition chamber 124:

NO₂(g)→½N₂(g)+O₂(g) (3)

Reaction (3) shows the reaction of nitrogen dioxide gas to form nitrogen and oxygen gas. As described herein, such reaction generally occurs in the presence of a catalytic converter, although it may not be required in some cases. In some embodiments, it may be advantageous to heat decomposition chamber 124 to a predetermined temperature range to facilitate the catalytic conversion of nitrogen dioxide into nitrogen and oxygen gas via Reaction (3). This heat may be provided to the decomposition chamber 140 using heat transferred from the first reaction chamber 100 via heat exchanger 134 and/or from a heater 132. Appropriate types of catalysts may include but are not limited to liquid phase scrubbers, catalytic converters (e.g., catalysts based on platinum, palladium, rhodium, etc.), selective catalytic reduction processes, 3d-non-noble metal catalysts (e.g., iron, cobalt, nickel, copper, etc.), metal oxide catalysts, zeolite catalysts, bimetallic complex catalysts, and/or other appropriate type of catalyst. The resulting nitrogen and oxygen gas may be subsequently transferred to a second storage chamber 126 via flow path 114, which may be configured to contain oxygen and nitrogen gas. However, instances in which a gas separation process for oxygen and nitrogen is performed using an appropriate gas separator and/or the gases are directly fed into a desired process or device for immediate use are also contemplated. Thus, in certain embodiments, it may be desirable to separate the nitrogen gas from the oxygen gas. For example, nitrogen gas may be filtered from the oxygen gas using any appropriate gas separation processes and/or system including for example: pressure swing adsorption (PSA) systems which may include typical adsorbent materials such as zeolites, silica, activated carbon, resins, and alumina, nitrogen dioxide filters such as activated carbon; carbon molecular sieving; and/or other appropriate separation and/or purification processes.

Nitrogen dioxide may decompose within decomposition chamber 124 in an appropriate temperature range. This temperature range may vary based on the type of catalyst used to facilitate the desired composition reaction. In some embodiments, the decomposition temperature of nitrogen dioxide is greater than or equal to 100° C., greater than or equal to 125° C., greater than or equal to 150° C., greater than or equal to 175° C., or greater than or equal to 200° C. In the embodiments, the decomposition temperature of nitrogen dioxide is less than or equal 200° C., less than or equal 175° C., less than or equal 150° C., less than or equal 125° C., or less than or equal 100° C. Combinations of the above-mentioned ranges are possible (e.g., greater than or equal to 100° C. and less than or equal to 200° C.).

In some embodiments, water may be produced and/or otherwise introduced into the oxygen generator during operation. In certain cases, at least a portion of water may be separated from other reaction products. In one aspect, reacting nitric acid and activated aluminum alloys may produce water, where water may be transported through sequentially connected chambers. Water can be separated from other reaction products in a number of ways described herein, although other ways are possible. For example, water can be transferred into a first storage chamber (e.g., a storage chamber configured to contain solid alumina), where the solid alumina can be filtered while water is removed from the first storage chamber. Another example involves using drying agents (e.g., magnesium sulfate, sodium sulfate, calcium chloride, etc.) to remove at least a portion of water present in the second storage chamber configured to contain nitrogen gas and/or oxygen gas. In yet another example, an optional flow path may be configured to remove water from the separation chamber or any other appropriate chamber described herein.

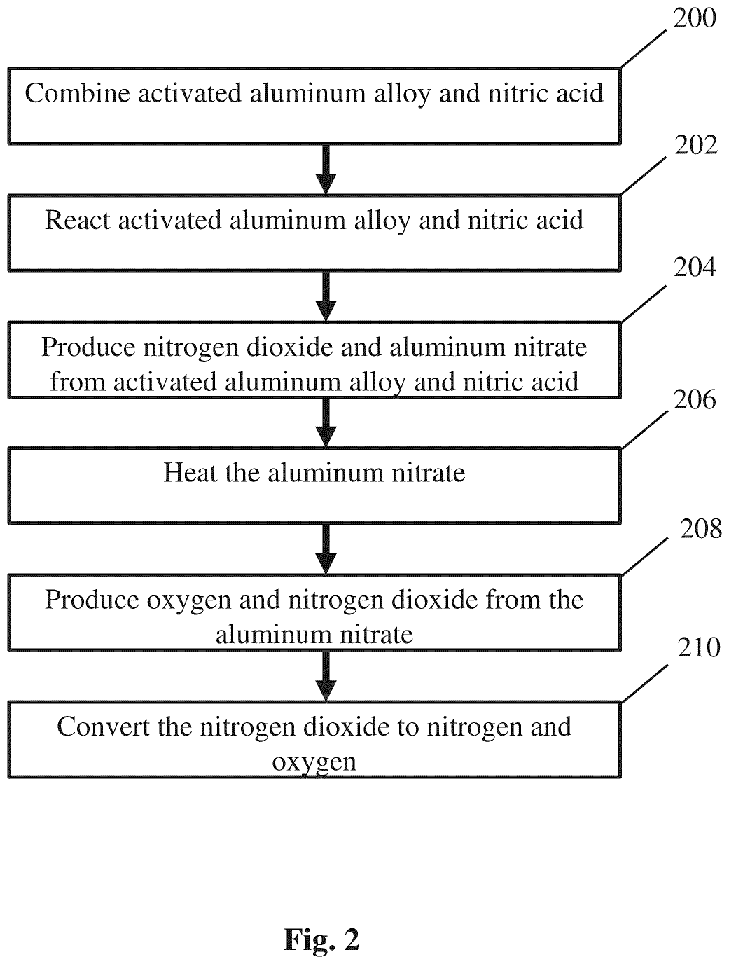

FIG. 2 depicts a generalized flow diagram for generating oxygen using the method and oxygen generator described above relative to FIG. 1. However, it should be understood that the disclosed reactions and methods may be performed using any appropriate batch (e.g., a single reactor), continuous (e.g., flow reactors), and/or semi-continuous (e.g., sequential batch reactors) arrangement as the disclosure is not limited to only using the specific generator described in FIG. 1. In the depicted embodiment, step 200 includes combining activated aluminum alloy and nitric acid in one or more reaction chambers, such as a first reaction chamber. One or more sources (e.g., a nitric acid feeder, an activated aluminum alloy feeder, etc.) may be configured to transfer activated aluminum and nitric acid to a first reaction chamber though other arrangements for transferring material from appropriate sources may be used. Step 202 includes reacting the activated aluminum alloy and nitric acid. The reaction between the activated aluminum alloy and nitric acid may be an exothermic reaction, as described herein. Step 204 includes producing nitrogen dioxide and aluminum nitrate, generally produced from the reaction of activated aluminum and nitric acid in step 202. Step 206 includes heating the aluminum nitrate, which generally involves heating the aluminum nitrate to a temperature greater than or equal to a decomposition temperature of the aluminum nitrate, as described herein in more detail. Step 208 includes producing oxygen and nitrogen dioxide from the aluminum nitrate produced during the thermal decomposition at 208 and/or during the reaction of the activated aluminum alloy and nitric acid at 202. Alumina may also be produced during the thermal decomposition. Step 210 includes converting the nitrogen dioxide (e.g., by exposing to a catalytic converter) to nitrogen gas and oxygen gas. As detailed previously above, this may be performed using a catalytic reaction. The resulting flow of gas may then be subjected to subsequent gas separation processes, storage, and/or use as detailed previously above.

In the above noted reactions, certain chemical species disclosed herein may be aqueous. Aqueous species may be dissolved or partially dissolved in water. Some non-limiting examples of aqueous species may include, but are not limited to aqueous nitric acid, aqueous aluminum nitrate, aqueous aluminum hydroxide, among others.

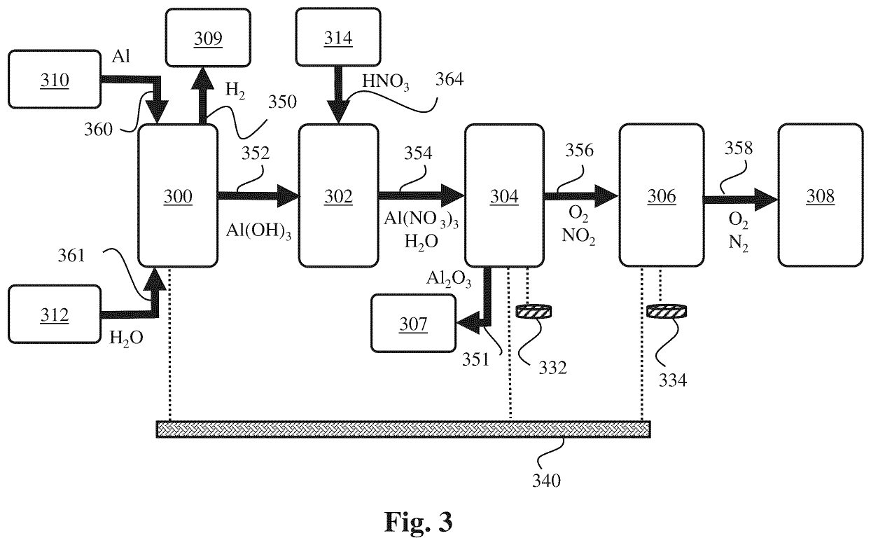

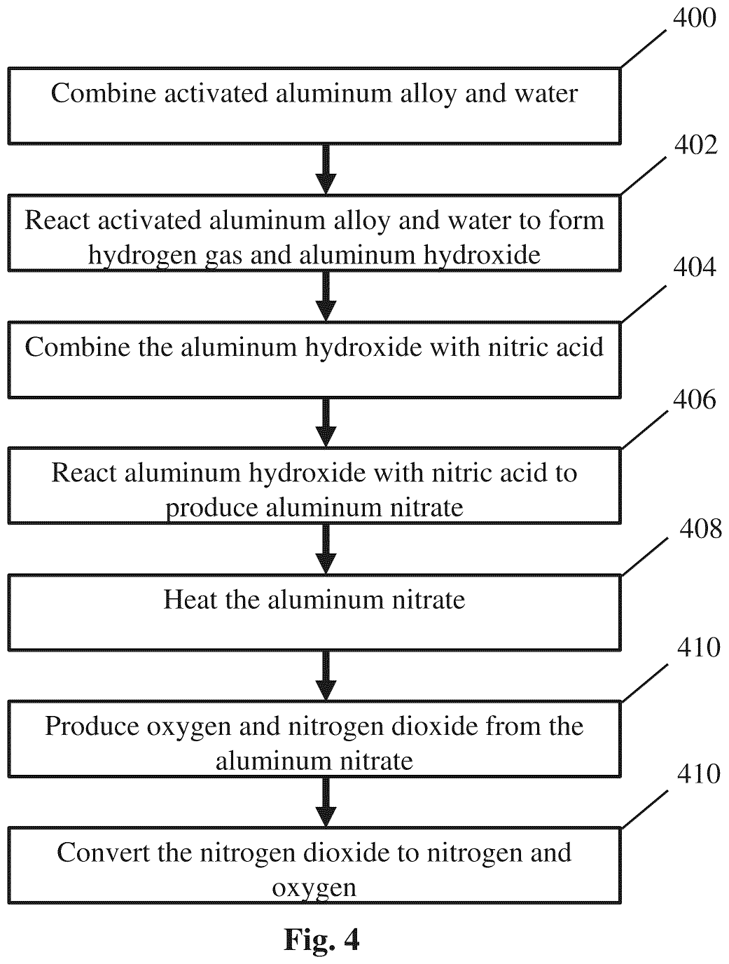

As activated aluminum alloy may also be used to produce hydrogen, in some embodiments, it may be desirable to produce hydrogen using an activated aluminum alloy prior to generating oxygen. Exemplary oxygen generators and corresponding methods in which both hydrogen and oxygen are generated are detailed further below in regard to FIGS. 3 and 4.

FIG. 3 schematically shows another embodiment of an oxygen generator for generating both hydrogen and oxygen using an activated aluminum alloy, water, and nitric acid through the production of an aluminum hydroxide precursor. In the depicted embodiment, activated aluminum alloy source 310 may be configured to feed or otherwise provide activated aluminum alloy via flow path 360 to first reaction chamber 300 and water source 312 may be configured to feed or otherwise provide water via flow path 361 to first reaction chamber 300 to produce hydrogen and aluminum hydroxide therein. First reaction chamber 300 may be configured to transfer the produced hydrogen via flow path 350 to third storage chamber 309. Alternatively, the flow path 350 may be configured to flow the hydrogen to a desired device for use. The first reaction chamber 300 may be configured to transfer aluminum hydroxide produced in the first reaction chamber 300 to second reaction chamber 302 via flow path 352. A nitric acid source 314 may be configured to feed or otherwise provide nitric acid to the second reaction chamber via flow path 364 to react with the aluminum hydroxide to produce aluminum nitrate. The aluminum nitrate, which may be suspended and/or dissolved in an aqueous solution, may be transported to a third reaction chamber 304 via flow path 354.

Similar to the description above relating to FIG. 1, a heater 332 and/or a heat exchanger 340 configured to transfer heat from the first reaction chamber 300 to the third reaction chamber may be configured to heat the third reaction chamber to a temperature equal to or greater than a decomposition temperature of the aluminum nitrate to produce oxygen, nitrogen dioxide, and alumina. The third reaction chamber may be configured to transfer alumina via flow path 351 to first storage chamber 307. Third reaction chamber 304 may also be configured to transfer oxygen and/or nitrogen dioxide to decomposition chamber 306 via flow path 356. Alternatively, while the third reaction chamber is depicted as separating the generated gas and solid materials, in some embodiments, a separate separation chamber similar to that disclosed in FIG. 1 may be connected to the third reaction chamber and the materials may be transferred from the third reaction chamber to the separation chamber for processing as described previously above.

Decomposition chamber 306, which again may function as previously discussed above relative to FIG. 1, may be configured to produce oxygen from the incoming nitrogen dioxide using a catalytic reaction. Similar to the embodiment of FIG. 1, the heat exchanger 340 and/or heater 334 may be configured to heat the decomposition chamber 306 to a desired operating temperature to facilitate the decomposition of nitrogen dioxide into oxygen and nitrogen. In either case, the resulting combined stream of oxygen and nitrogen may be output to second storage chamber 308 via flow path 358 and/or to any other desired end use as previously discussed. Additionally, as also noted above, the stream of oxygen and nitrogen may be subjected to one or more purification and/or separation processes to separate out the nitrogen and/or oxygen into separate flows of gas for one or more desired end uses.

The above described oxygen generator may be used to perform a reaction between nitric acid and aluminum hydroxide generated by a reaction between an activated aluminum alloy and water to generate oxygen. An example of one exemplary reaction pathway is shown below:

One example of a reaction which may be performed using the oxygen generator of FIG. 3, or other appropriate batch, continuous, or semi-continuous oxygen generator, is provided below. In this process, an activated aluminum alloy may react in the presence of water via the following reaction:

2Al(s,activated)+6H₂O(l)→3H₂(g)+2Al(OH)₃(s) (4)

Based on Reaction (4), activated aluminum alloys may react with water to form hydrogen and aluminum hydroxide. In relation to FIG. 3, Reaction (4) may occur within first reaction chamber 300. First reaction chamber 300 may be configured to transfer aluminum hydroxide via flow path 352 to a second reaction chamber 302 and transfer hydrogen to third storage container 309 via flow path 350. In addition, Reaction (4) is generally exothermic. In certain cases, heat generated from Reaction (4) may be transferred to other chambers (e.g., separation chamber) within the system.

The first reaction chamber 300 may be configured to generate aluminum hydroxide at any suitable temperature that is above a freezing point and below a boiling point of the solution contained therein. In some embodiments, the first reaction chamber may be configured to maintain a temperature appropriate to generate aluminum hydroxide that is greater than or equal to 1° C., greater than or equal to 20° C., greater than or equal to 40° C., greater than or equal to 60° C., greater than or equal to 80° C., or greater than or equal to 99° C. The first reaction chamber may be configured to generate aluminum hydroxide at a temperature that is less than or equal 99° C., less than or equal to 95° C., less than or equal to 80° C., less than or equal to 60° C., less than or equal to 40° C., less than or equal to 20° C., or less than or equal to 1° C. Combinations of the above-recited ranges are possible (e.g., greater than or equal to 1° C. and less than or equal to 99° C.).

The resulting aluminum hydroxide may gen be reacted with nitric acid as shown below:

3HNO₃(aq)+Al(OH)₃(s)→Al(NO₃)₃(aq)+3H₂O(l) (5)

For example, according to certain embodiments, aluminum hydroxide (e.g., solid aluminum hydroxide) may react with nitric acid to form aluminum nitrate and water. Referring to FIG. 3, Reaction (5) may occur within second reaction chamber 302.

According to some embodiments, the concentration ratio of nitric acid to aluminum hydroxide may be any suitable range. For example, a suitable concentration ratio (e.g., molar concentration ratio) of nitric acid to aluminum hydroxide may promote a reaction between the nitric acid and aluminum hydroxide. In some embodiments, the concentration ratio of nitric acid to aluminum hydroxide is greater than or equal to 15:1, greater than or equal to 12:1, greater than or equal to 9:1, greater than or equal to 6:1, greater than or equal to 5:1, greater than or equal to 4:1, greater than or equal to 3:1, greater than or equal to 2:1, or greater than or equal to 1:1. In some embodiments, the concentration ratio of nitric acid to activated aluminum is less than or equal to 1:1, less than or equal to 2:1, less than or equal to 3:1, less than or equal to 4:1, less than or equal to 5:1, less than or equal to 6:1, less than or equal to 9:1, less than or equal to 12:1, or less than or equal to 15:1. Combinations of the above-recited ranges are possible (e.g., greater than or equal to 1:1 and less than or equal to 15:1). The concentration ratio of nitric acid to aluminum hydroxide may be the concentration ratio prior to reacting. Without wishing to be bound by theory, it may be desirable to have a stoichiometric excess of nitric acid with regards to aluminum hydroxide.

As seen in FIG. 3, third reaction chamber 304 may be configured to receive the aluminum nitrate (e.g., aqueous aluminum nitrate, solid aluminum nitrate) from second reaction chamber 302. Second reaction chamber 302 may be configured to undergo the following reaction:

2Al(NO₃)₃(s)+Δq→Al₂O₃(s)+1.5O₂(g)+6NO₂(g) (6)

As shown in reaction (6), the aluminum nitrate may be thermally decomposed in a manner similar to that disclosed above to produce alumina, oxygen, and nitrogen dioxide. Water may be removed from third reaction chamber 304 through an opening on the chamber. Alternatively, a mixture of water and aluminum hydroxide may be transferred to the first storage chamber 307 and subsequently separated by filtration (as described above). In certain embodiments, water may be removed, after transferring nitrogen dioxide and oxygen gas to another chamber (e.g., decomposition chamber 306), by evaporating the water.

Again, the decomposition chamber may be configured to perform a catalytic reaction with nitrogen dioxide to produce nitrogen and oxygen according to the following:

NO₂(g)→½N₂(g)+O₂(g) (7)

Reaction (7) shows the decomposition reaction of nitrogen dioxide gas to form nitrogen and oxygen gas. As described herein, such reaction generally occurs in the presence of a catalytic converter, although it may not be required in some cases. It may be advantageous to heat decomposition chamber 306 to accelerate Reaction (7), where such heat may be received from heat exchanger 140 and/or heater 134.

As previously described, water and activated aluminum alloys may react to produce hydrogen gas. In certain embodiments, the rate and amount of hydrogen gas produced can be controlled by tuning the properties (e.g., metal content, size) of the activated aluminum alloys. In certain cases, aluminum hydroxide may form a slurry in the presence of water. Although not necessary, the aluminum hydroxide filtered may be filtered (e.g., mechanically filter) to reduce the water concentration (e.g., before being exposed to nitric acid).

FIG. 4 depicts a generalized flow diagram for generating oxygen using an aluminum hydroxide precursor in a manner similar to that described above relative to FIG. 3. Thus, it should be understood that any of the steps described in FIG. 4 are applicable to FIG. 3 and vice versa. Step 400 may include combining activated aluminum alloy and water in a reaction chamber from one or more associated sources. Step 402 may include reacting the activated aluminum alloy and water to form hydrogen gas and aluminum hydroxide. The hydrogen gas may be transferred to a storage container and/or alternatively, a portion of the generated hydrogen gas may be used in a combustion process to provide heat for one or more of the other subsequent steps. Step 404 may include combining aluminum hydroxide with nitric acid. Step 406 may include producing aluminum nitrate from the reaction between aluminum hydroxide and nitric acid. Step 408 may include heating the aluminum nitrate to a sufficiently elevated temperature to cause decomposition of the aluminum nitrate. Step 410 include producing nitrogen dioxide from the thermal decomposition of the aluminum nitrate. Step 410 includes converting nitrogen dioxide to nitrogen and oxygen (e.g., nitrogen gas and oxygen gas).

The following examples are intended to illustrate certain embodiments of the present disclosure, but do not exemplify the full scope of the disclosure.

### Example: Generating Oxygen Using Activated Aluminum Alloys and Nitric Acid

This example describes systems and methods for oxygen production from activated aluminum alloys and nitric acid. This may involve electricity free production of hydrogen gas (fuel) and oxygen gas (oxidizer) from activated aluminum metal, water and a solution of an inorganic acid in water. The on-demand, coproduction of these gases allows high-efficiency, austere fuel cell electricity generation; combustion systems for heat and/or mechanical work including engines/generators, and other desirable applications.

Activated aluminum has emerged as a new technology for energy storage, transport, and the ability to generate large volumes of hydrogen gas very quickly in austere locations, without sophisticated equipment or sizeable power draws. Activated aluminum reacts readily with water to produce hydrogen gas, and typically aluminum hydroxide as a (solid) byproduct. While the discovery of activated aluminum has to some degree ‘solved’ the ‘hydrogen on demand’ problem, it has created another problem—namely an ‘oxygen on demand’ problem.

Table 1 below indicates the top four constituents of Earth's atmosphere.

TABLE 1
Constituents of Earth's atmosphere.

| Gas | Symbol | Content |
|---|---|---|
| Nitrogen | N₂ | 78.084% |
| Oxygen | O₂ | 20.947% |
| Argon | Ar | 0.934% |
| Carbon dioxide | CO₂ | 0.035% |

Oxygen comprises 20% of Earth's atmosphere; thus for energy applications where hydrogen is combined with oxygen, in scenarios where pure oxygen is not required, it is generally acceptable to generate (pure) hydrogen gas on demand and rely upon using atmospheric oxygen for reactions. Examples of this would be operation of a hydrogen fuel cell (i.e., to power a car), or burning of hydrogen to operate a steam generator to make electricity or to simply provide heat.

Other applications of hydrogen and oxygen may require pure streams of both hydrogen and oxygen. These applications include the operation of hydrogen fuel cells in enclosed environments, such as on underwater vehicles, high altitude aircraft, or space-based applications. In these scenarios, it is desirable to bring along oxygen in stoichiometric balance with hydrogen for operation. Other applications include the use of pure hydrogen and oxygen to operate high temperature flame torches for use as rocket propellants, where pure streams of both hydrogen and oxygen are sometimes compressed and liquefied prior to launch.

With traditional hydrogen generation equipment (i.e. a water fed electrolyzer), both hydrogen and oxygen are cogenerated at the ideal 2:1 stoichiometric ratio; however, this cogeneration comes at substantial costs (in terms of both monetary expense of equipment and required electrical energy input). In austere environments (i.e., “desert island” scenarios), the electrical infrastructure simply does not exist to operate such electrolyzers on a mass scale.

Activated aluminum presents an attractive and durable way of generating hydrogen (alone) in such environments (by simply adding water), but its traditional use does nothing to address cogeneration of oxygen. See reaction 8 below for the reaction of activated aluminum with water to generate hydrogen gas.

2Al(s,activated)+6H₂O(l)→2Al(OH)₃(s)+3H₂(g) (8)

The aluminum metal in reaction 1 generally participates in this reaction if it has been “activated”. One incarnation of activated aluminum metal is created by infusing/dissolving the aluminum matrix with ˜3% activating metals (typically a eutectic mixture of indium and gallium liquid metals). The presence of these activating metals, in one mechanistic theory, is thought to disrupt the formation of passivating oxide layers on the aluminum metal, thus allowing rapid reaction with water.

The technology described herein further leverages activated aluminum. Specifically, this non-limiting example describes methods by which either activated aluminum or aluminum hydroxide can be reacted with a nitric acid (solution or gas) to directly generate aluminum nitrate, a sat that can be subsequently heated for cogeneration of oxygen gas.

Without wishing to be bound by theory. ‘standard’ aluminum metal does not react directly with nitric acid:

Al(s)+HNO₃(aq)→no reaction (9)

This is because of the presence of a microscopic layer of passivating aluminum oxide (Al₂O₃, i.e. sapphire) that coats aluminum surfaces that have been in contact with Earth's atmosphere (due to the oxygen content indicated in Table 1). Through recent experiments, it has been shown that activated aluminum actually does react readily with nitric acid via the following novel reaction:

Al(s,activated)+6HNO₃(aq)→Al(NO₃)₃(aq)+3H₂O(l)+3NO₂(g) (10)

Without wishing to be bound by theory, this is attributed to the theorized disruption of the formation of an oxide layer that prevents reaction 9 from proceeding. Note that hydrogen is not indicated as a product in the reaction, as most hydrogen generated by reaction of acid with aluminum is immediately oxidized by nitrate (to form NO₂(g) and water). It is also notable that insoluble aluminum hydroxide (typically formed upon reaction of active aluminum with water) is in general not formed in reaction 10. Instead, highly soluble aluminum nitrate is formed, which immediately dissolves. The resulting solution can be evaporated to yield dry solid aluminum nitrate with thermal energy supplied, which may be provided at least partially from reaction 10 (which is exothermic), by combustion of some of the hydrogen generated in a separate reaction chamber by reaction 8 (with ambient oxygen) as desired. The resulting dry aluminum nitrate solid can in turn be heated (˜150° C.) such that it thermally decomposes to cogenerate oxygen gas and nitrogen dioxide (a recurring unwanted byproduct):

2Al(NO₃)₃(s)+Δq→Al₂O₃(s)+1.5O₂(g)+6NO₂(g) (11)

Nitrogen dioxide is undesirable for a number of reasons. However, commercial technology such as liquid phase scrubbers, catalytic converters and SCR (selective catalytic reduction) processes exist to convert nitrogen dioxide to nitrogen gas and oxygen gas:

NO₂(g)→½N₂(g)+O₂(g) (12)

Thus, the gaseous byproduct NO₂(g) from both reactions 10 and 11 can be ‘harvested’ for oxygen gas. The resulting oxygen gas stream is still ‘contaminated’ with nitrogen gas. This may or may not inhibit utility of the resulting oxygen stream (application dependent), but further purified oxygen can still be achieved by several methods. Perhaps the most practical in this situation is the use of off-the-shelf pressure swing adsorption (PSA) systems. Typical adsorbent materials used for PSA include zeolites, silica, activated carbon, resins and alumina. It is notable that alumina is generated as a byproduct in reaction 11. Thus, another aspect of the disclosed process may be that this process may produce its own PSA media as a byproduct. In other words, in some embodiments, the produced alumina byproduct may be used to help separate the produced nitrogen gas and oxygen gas.

There is another, sequential pathway for generation of aluminum nitrate, for scenarios where more efficient use of the activated aluminum is desired. This scenario involves neutralization of the aluminum hydroxide solid (byproduct in reaction 8) with a solution of nitric acid:

3HNO₃(aq)+Al(OH)₃(s)→Al(NO₃)₃(aq)+3H₂O(l) (13)

Reaction 13 is an acid/base neutralization reaction. The above reactions can be used to describe two non-electrolyzer based H₂/O₂ cogeneration pathways. The first reaction path detailed above includes reaction 8 to generate hydrogen gas, while simultaneously carrying out reactions 10-12 to generate oxygen gas. This second pathway includes reaction 8 to generate hydrogen gas, with the solid byproduct of reaction 8 may be fed to reaction 13 to generate aluminum nitrate, with reactions 11 and 12 generating oxygen. Pathway one may be more straightforward in terms of apparatus and time but may use more activated aluminum. Pathway two may be more efficient in terms of use of activated aluminum, but it may use more time and apparatus complexity (due to the sequential nature of the reactions). Pathway two generates 7.5 moles of oxygen gas for every 3 moles of hydrogen gas generated (in the limiting case of 100% stoichiometric efficiency). This ratio of gases well exceeds the desired 2:1 ratio of hydrogen to oxygen for maximal stoichiometric reaction, but it does provide significant coverage for loss of material if reactions 11, 12 and the PSA purification process are not 100% efficient. (Hydrogen generation from activated aluminum tends to be better than 95% efficient, given proper reaction conditions.) If for some reason catalytic reduction of NO₂(g) is not a desirable or feasible step for an application, reaction 11 alone generates 1.5 moles of O₂ for every 3 moles of H₂ generated, the ideal 2:1 molar ratio for reaction previously described. In that scenario, separation of unwanted NO₂ would remain a problem.

Typically, if “pure” oxygen is generally ideal to react with hydrogen gas generated from activated aluminum at a remote location, oxygen must be shipped to the location or independently generated onsite. Shipment is typically in the form of form of compressed gas cylinders (which are heavy and cumbersome) or via highly specialized cryogenic liquid tankers. Independent onsite generation has significant costs, in terms of expensive equipment, consumables and significant electrical input. Modern oxygen generators rely upon expensive consumable filters, have a relatively small production rate of purified oxygen, and require significant electrical input. Electrolyzers (which split water into both hydrogen and oxygen) are expensive, require substantial electricity to split the (stable) water molecules, and carry the added burden of requiring high purity water for operation. (High purity water has its own logistical challenges, in terms of cost of equipment, power draw and consumables.) For some niche applications (i.e. emergency breathing oxygen on commercial aircraft), “oxygen candles” are used to generate pure oxygen, via the heating of solid chlorate salts. For those applications, sodium chlorate is an alternative. That said, from a practicality point of view, sodium chlorate may need to be heated to 300° C. in order to release oxygen. Aluminum nitrate can liberate oxygen at a lower temperature: 150° C. and the exothermic nature of the aluminum/water reaction can provide a fair amount of that thermal energy. So, for austere application spaces, the thermodynamic hurdle posed by sodium chlorate “oxygen candle” technology may be impractical as compared to the disclosed technology. In contrast, nitric acid and activated aluminum may be shipped and stored as non-refrigerated liquids and solids,

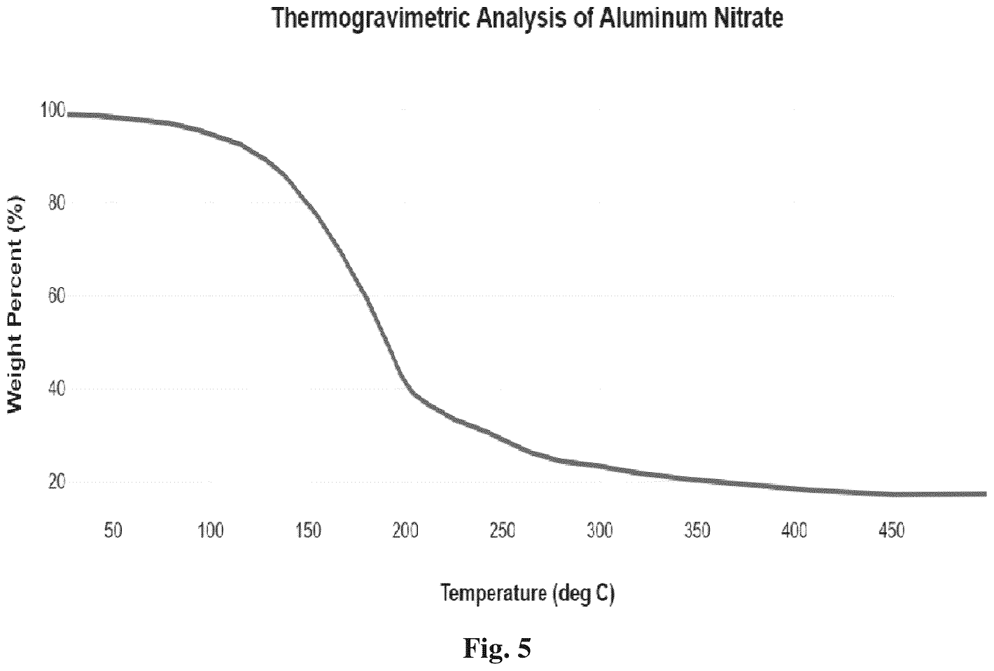

The following description describes an experiment that was performed to generate oxygen and corresponds to the process illustrated relative to FIG. 1. Activated aluminum was reacted with a solution of nitric acid, producing a vigorous reaction that generates both heat and byproduct nitrogen dioxide (observed brown gas). The desired (observed) result of this reaction was aluminum nitrate, highly soluble in water (in stark contrast with reaction of activated aluminum and pure water). The resulting solution was heated on a hotplate to produce a solid precipitate (once all of the water had been boiled off). The resulting solid was consistent in appearance to aluminum nitrate, and the mass of solid was consistent with the expected mass of aluminum nitrate to be generated. A thermogravimetric analysis (TGA) was run (in which the sample was heated to off-gas both oxygen and nitrogen dioxide). The resultant TGA curve (FIG. 5) was characteristic of an aluminum nitrate TGA curve from the literature.

The following description describes pathway two which was performed experimentally and corresponds to the process described schematically relative to FIG. 3. It has been established that activated aluminum reacts readily with water to produce aluminum hydroxide. Experiments were carried out in which dried aluminum hydroxide was reacted with a nitric acid solution. The reaction was observed to be vigorous, and when stoichiometric excess of nitric acid was added to the aluminum hydroxide, a completely soluble solution was observed. This is consistent with the conversion of aluminum hydroxide (s), which is highly insoluble in water, to aluminum nitrate (aq), which is highly soluble. pH measurements of the resulting solution also indicated a neutralization of the nitric acid base, which is the result from a reaction between a strong acid and a sparingly soluble base.

While several embodiments of the present disclosure have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the disclosure described herein. It is, therefore, to be understood that the foregoing embodiments are presented by way of example only and that, within the scope of the appended claims and equivalents thereto, the invention may be practiced otherwise than as specifically described and claimed. The present disclosure is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

1. A method for producing oxygen gas, the method comprising:
producing aluminum nitrate using an activated aluminum alloy and nitric acid; and
heating the aluminum nitrate to produce the oxygen gas.

2. The method of claim 1, wherein the activated aluminum alloy includes gallium and/or indium.

3. The method of claim 1, wherein the activated aluminum alloy includes bismuth and/or tin.

4. The method of claim 1, wherein producing aluminum nitrate includes reacting the activated aluminum alloy with nitric acid to produce the aluminum nitrate.

5. The method of claim 1, wherein producing aluminum nitrate includes precipitating aluminum nitrate.

6. The method of claim 5, wherein precipitating aluminum nitrate includes evaporating water.

7. The method of claim 1, wherein producing aluminum nitrate includes reacting the activated aluminum alloy with water to produce aluminum hydroxide, and further comprising reacting the aluminum hydroxide with the nitric acid to produce the aluminum nitrate.

8. The method of claim 7, wherein reacting the activated aluminum alloy with the water produces hydrogen.

9. The method of claim 7, wherein reacting the aluminum hydroxide with the nitric acid includes reacting the aluminum hydroxide with a stoichiometric excess of the nitric acid.

10. The method of claim 1, further comprising combusting at least a portion of the hydrogen to heat the aluminum nitrate.

11. The method of claim 1, wherein reacting the activated aluminum alloy with the nitric acid produces nitrogen dioxide.

12. The method of claim 1, wherein heating the aluminum nitrate produces nitrogen dioxide.

13. The method of claim 1, wherein heating the aluminum nitrate produces aluminum oxide.

14. The method of claim 1, further comprising converting the nitrogen dioxide to nitrogen gas and oxygen gas.

15. The method of claim 14, further comprising separating the nitrogen gas and the oxygen gas.

16. An oxygen generator comprising:
one or more chambers;
an activated aluminum alloy source configured to provide activated aluminum alloy to at least one of the one or more chambers;
a nitric acid source configured to provide nitric acid to at least one of the one or more chambers to produce aluminum nitrate using the activated aluminum alloy and the nitric acid; and
a heater configured to heat the aluminum nitrate to a temperature greater than a decomposition temperature of the aluminum nitrate to produce oxygen gas.

17. The oxygen generator of claim 16, wherein the one or more chambers includes a reaction chamber, and wherein the activated aluminum source and the nitric acid source are configured to provide the activated aluminum alloy and the nitric acid to the reaction chamber to react the activated aluminum alloy and the nitric acid to produce the aluminum nitrate.

18. The oxygen generator of claim 16, further comprising a water source configured to provide water to the one or more chambers to react the water with the activated aluminum alloy to produce aluminum hydroxide, and wherein the nitric acid source is configured to provide the nitric acid to the one or more chambers to react the aluminum hydroxide with the nitric acid to produce the aluminum nitrate.

19. The oxygen generator of claim 16, further comprising the aluminum alloy, wherein the activated aluminum alloy includes gallium and/or indium.

20. The oxygen generator of claim 16, further comprising the aluminum alloy, wherein the activated aluminum alloy includes bismuth and/or tin.

21. The oxygen generator of claim 16, wherein the aluminum nitrate comprises an aqueous solution of aluminum nitrate.

22. The oxygen generator of claim 16, wherein the heater is configured to heat at least one of the one or more chambers configured to contain the aluminum nitrate.

23. The oxygen generator of claim 16, wherein the heater comprises a heat exchanger configured to at least partially heat the aluminum nitrate using energy released from an exothermic reaction of the activated aluminum alloy.

24. The oxygen generator of claim 23, wherein when the heater heats the aluminum nitrate to the temperature greater than the decomposition temperature of the aluminum nitrate nitrogen dioxide gas is produced.

25. The oxygen generator of claim 24, further comprising a catalytic converter configured to convert the nitrogen dioxide gas to nitrogen gas and oxygen gas.
